(19) United States
(12) Patent Application Publication
(10) Pub. No.: US 2009/0031598 A1
(43) Pub. Date: Feb. 5, 2009

(54) Value stream simulation and display board

(75) Inventors: Amrit Soni, Peoria, IL (US); Paul A. Malnati, St.Paul, MN (US)

Correspondence Address: CATERPILLAR/FINNEGAN, HENDERSON, L.L.P., 901 New York Avenue, NW, WASHINGTON, DC, 20001-4413, US

(73) Assignee: Caterpillar Inc.

(21) Appl. No.: 11/882,241

(22) Filed: Jul. 31, 2007

(51) Int. Cl. G09F 7/04

(52) U.S. Cl. 40/600

(57) ABSTRACT

A method is disclosed. The method includes developing an initial value stream map for a process, identifying a plurality of entities to be monitored during completion of the process based on the initial value stream map, and determining an initial layout of the process based on the plurality of entities to be monitored. The method also includes providing the initial layout of the process on a metallic display board, and placing magnetic elements corresponding to the plurality of entities on the initial layout to describe the process.

### TECHNICAL FIELD

This disclosure relates generally to value stream simulation techniques, and, more particularly, to a value stream simulation and display board.

### BACKGROUND

Every business executes a sequence of steps to provide products and/or services to customers. A value stream can be thought of as the flow of materials and/or information required to bring a product and/or service from order to delivery. Today, many businesses emphasize a “lean implementation” philosophy of reducing waste by targeting inefficiencies in the value stream. Waste can be defined as any activity that does not add value to the final product. In a production environment, common types of waste may include, for example, overproduction, motion (e.g., of an operator or a machine), waiting time (e.g., of an operator or a machine), transport, unnecessary processing, excess inventory, and rework.

In order to remain competitive in a global market, businesses have developed strategic planning and communication tools to improve efficiency and reduce waste. On such tool is known as a value stream map, which can be used to visualize a current state of the process by showing the flow of information and/or materials within the process. A value stream map may, for example, illustrate relationships between various steps in the process and include cycle times, down times, in-process inventory, information flows, and/or other pertinent information about the steps. In this manner, a value stream map may be used to and identify deficiencies in the process and the causes thereof.

Because value stream mapping may involve the analysis of many variables, a variety of tools have been developed to aid in the creation and the simulation of value stream maps. One tool for simulating a value stream map is disclosed in U.S. Patent Application Publication No. 2007/0073421 by Adra, published on Mar. 29, 2007 (the '421 publication). The '421 publication discloses a computer system that allows a user at an interface to simulate, analyze, and evaluate a value stream subjected to desired conditions and scenarios. Specifically, at the start of or during a simulation of a particular value stream, the user configures and selects desired value stream metrics (e.g., value added time, efficiency, TAKT time, objects completed, objects in progress, load time, unload time, etc.) to be evaluated. The user can analyze the value stream when subjected to desired conditions (i.e., a “what-if” scenario) by reconfiguring and/or reselecting value stream metrics during the simulation. The results of the simulation are displayed via the user interface.

Although the tool of the '421 publication allows dynamic simulation of a value stream under a variety of conditions, its application may be limited. In particular, because the tool is provided through the user interface of a computer system, only a single user can access the tool and perform a simulation at a time. For this same reason, the tool may be ineffective in communicating the results of a simulation to those it may concern. In a manufacturing environment, for example, the results of a simulation may be valuable to a variety of personnel, such as, engineers, technicians, management, suppliers, customers, etc. Further, at least some of the personnel may have knowledge, information, and/or other input with respect to configuring and performing the simulation, but may be unable to participate due to the nature of the tool.

The present disclosure is directed to overcoming one or more of the problems set forth above.

### SUMMARY OF THE INVENTION

One aspect of the disclosure is directed to a method. The method may include developing an initial value stream map for a process, identifying a plurality of entities to be monitored during completion of the process based on the initial value stream map, and determining an initial layout of the process based on the plurality of entities to be monitored. The method may also include providing the initial layout of the process on a metallic display board, and placing magnetic elements corresponding to the plurality of entities on the initial layout to describe the process.

Another aspect of the invention is directed to a method of improving a process. The method may include developing a value stream map for the process, identifying a plurality of entities to be monitored during completion of the process based on the value stream map, and determining a layout of the process based on the plurality of entities to be monitored. The method may further include providing the layout of the process on a metallic display board, and placing magnetic elements corresponding to the plurality of entities on the layout to describe the process.

### BRIEF DESCRIPTION OF THE DRAWINGS

FIG. 1 shows a diagrammatic and schematic representation of a value stream;

FIG. 2 illustrates an exemplary display board to simulate a process of the value stream of FIG. 1;

FIG. 3 illustrates exemplary disclosed magnetic elements for use with the display board of FIG. 2; and

FIG. 4 shows a flow chart describing exemplary useage of the display board of FIG. 3 and the magnetic elements of FIG. 3.

### DETAILED DESCRIPTION

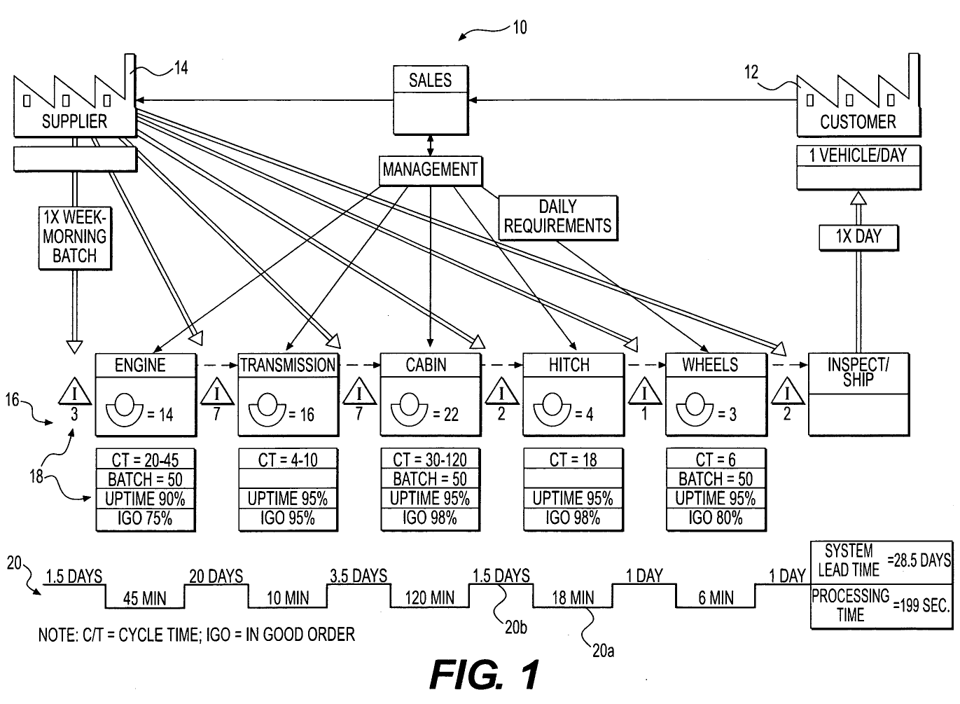

FIG. 1 shows an exemplary value stream map 10 illustrating various processes of a business. Value steam map 10 may be hand-drawn, computer-drafted, or otherwise created by those having knowledge about the particular value stream and/or business process, such as, for example, engineers, technicians, management, customers, and/or other personnel associated with the business. Value stream map 10 may be a concept-to-launch value stream, a raw material-to-finished-good value stream, an information technology (IT) value stream, or another type of value stream known in the art. A business may perform a variety of processes that may be illustrated by value stream map 10. For example, a business may assemble vehicles from components and subassemblies ordered from suppliers, and sell the assembled vehicles to customers.

Value stream map 10 may include a variety of symbols and/or other features to visually depict the particular value stream. For example, value stream map 10 may include a customer 12, a supplier 14, and a sequence of stations 16. Each of stations 16 may include information 18 about the particular station. For example, information 18 may include, a name or description, a number of workers required, a cycle time (i.e., the total amount of time required to perform the step), a batch size (i.e., the number of units processed by the station per cycle), an uptime (i.e., the percentage of time that the station is available for processing), a percentage of units processed correctly, an amount of inventory (i.e., backlog), etc. Value stream map 10 may also include a timeline 20. Timeline 20 may show, for example, a value added time, or processing time 20a (i.e., an amount of time the station is actually working and adding value to the product), and a non-value added time, or lead time 20b (i.e., an amount of time the product waits before work is started) for each station 16 Timeline 20 may be used to calculate total cycle time, total process lead time, total processing time, efficiencies, and/or other parameters of interest. It is to be appreciated that value stream map 10 may include additional, fewer, and/or different features than those shown in FIG. 1 to visually depict the flow of materials, information, and/or production through the value stream in a desired manner.

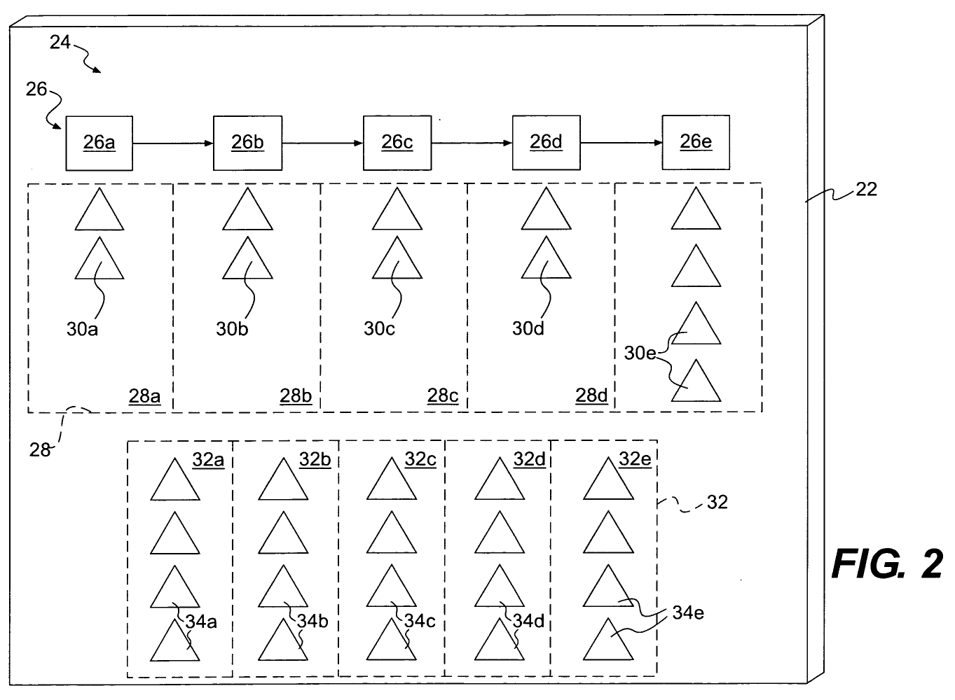

FIG. 2 shows an exemplary display board 22 that may be configured to display a visual representation of a business process (e.g., assembly of a vehicle). In particular, display board 22 may be used by business personnel to model and/or simulate the process, identify waste or other deficiencies in the process, and formulate improvements to reduce the waste and/or remedy the deficiencies. Display board 22 may be a metallic board, such as, for example, a dry-erase board, a chalkboard, or another suitable metallic surface that can be used to convey information. In a manufacturing process example, display board 22 may be mounted in a production office or on the production floor and configured by a production managers, engineers, assembly line workers, and/or other personnel associated with the business. Preferably, display board 22 may be sufficiently large and conspicuous to convey information and/or be simultaneously accessible to those who may have an interest in the particular process. It is to be appreciated, however, that display board 22 may be any desired size and/or have any suitable degree of visibility.

Display board 22 may have thereon a predetermined layout 24 of the business process. For example, layout 24 may comprise a pictorial laminate secured to display board 22; a hand-drawn or computer-drafted poster secured to display board 22; painted, drawn, or otherwise visually distinguished portions of display board 22; and/or other suitable artwork on display board 22. In one aspect, layout 24 may be designed by the business personnel for a particular business process based at least in part on the information conveyed by and/or contained in value stream map 10. In the manufacturing example mentioned above, layout 24 may represent the configuration of a vehicle assembly line process, and include pertinent inputs/outputs to/from the process.

Referring to FIG. 2, layout 24 may include a process 26 (e.g., assembly line manufacturing process). Process 26 may be divided in to a plurality of steps 26a-e. Continuing with the example discussed above, steps 26a-e may each represent a stage at which some type of work is performed on a vehicle. That is, the sequence of process steps 26a-e may represent the various stages of the assembly line. For example, steps 26a-e may represent a steps at which an engine subassembly, a transmission subassembly, an operator cabin subassembly, a hitch subassembly, and wheels, respectively, are installed on the vehicle.

Layout 24 may also include a first storage area 28. First storage area 28 may represent locations at which components, subassemblies, and/or other items are stored, immediately prior to being used and/or consumed in process 26. In one embodiment, first storage area 28 may represent a line-side storage area in the vicinity of the assembly line. First storage area 28 may be divided into one or more segments 28a-e, each segment 28a-e representing a respective component, subassembly, and/or item contained in first storage area 28. Each of segments 28a-e may be associated with a particular one of process steps 26a-e. That is, the subassemblies, components, and/or items stored in each of segments 28a-e may be used and/or consumed in a process steps 26a-e, respectively. Continuing with the example from above, segments 28a-e may contain one or more engine subassemblies, transmission subassemblies, operator cabin subassemblies, hitch subassemblies, and wheels, respectively. Further, each of segments 28a-e may include one or more markers 30a-e indicating a quantity of the particular subassembly, component, or item to be stored in each of segments 28a-e. Markers 30a-e may be, for example, colored triangles or other symbols known in the art to indicate subassemblies, components, items, and/or other entities that are consumed during the completion of a process. Segments 28a-e and/or markers 30a-e may also include a textual label (not shown) to further clarify the type of subassembly, component, and/or item stored in first storage area (e.g., “engine,” “transmission,” etc.)

Layout 24 may further include a second storage area 32. Second storage area 32 may represent a location at which inventory is stored prior to being transported to first storage area 28. For example, second storage area 32 may represent a warehouse, a designated inventory storage zone on the production floor, or another area that may be replenished by one or more suppliers during completion of process 26. Like first storage area 28, second storage area 32 may be divided into one or more segments 32a-e, each of segments 32a-e representing a respective subassembly, component, and/or item contained in second storage area 32. Likewise, each of segments 32a-e may include one or more markers 34a-e and/or textual labels (not shown) indicating a quantity and/or a type of the particular subassembly, component, and/or item stored in second storage area 32.

It is to be appreciated that layout 24 may include additional, fewer, and/or different features displayed in configurations other than those described above and shown in FIG. 2. That is, layout 24 is intended to be exemplary only, as a particular layout 24 may depend on the type of business, value stream, and/or process involved. Further, layout 24 may depend on the particular aspects of the business, value stream, and/or process chosen by the business personnel for representation on display board 22.

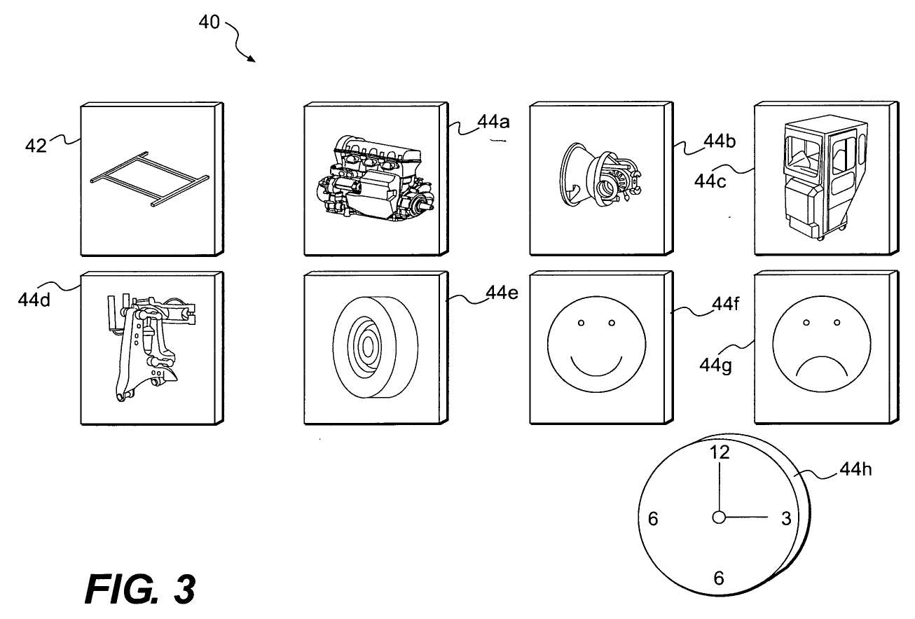

FIG. 3 shows exemplary elements 40 that may be placed on display board 22 to model, describe, and/or simulate process 26. In one embodiment, elements 40 may be magnetic pieces that can be selectively placed on display board 22 and moved about layout 24. Magnetic elements 40 may correspond to different value stream entities to be tracked and/or monitored during simulation of process 26. The entities may include, for example, subassemblies, components, the product to be assembled, storage containers, transport vehicles, workers, statuses (e.g., operational or waiting), time of day, and/or other pertinent entities to track when describing, modeling, and/or simulating process 26.

As shown in FIG. 3, magnetic elements 40 may include images corresponding to, for example, a vehicle chassis 42, an engine subassembly 44a, a transmission subassembly 44b, an operator cabin subassembly 44c, an a hitch subassembly 44d, wheels 44e, an “operational” status 44f, a “waiting” status 44g, a clock 44h, etc. It is to be appreciated, however, that any desired entity may be represented by magnetic elements 40. Further, magnetic elements 40 may have any type of visual distinction, such as, for example, images, symbols, icons, pictures, colors, and/or other suitable features. The visual distinctions may include, for example, printed stickers, laminates, hand-drawings, or other artwork.

### INDUSTRIAL APPLICABILITY

The disclosed simulation tool may be useful in situations where it is advantageous to visually describe, model, and/or simulate a value stream process to identify deficiencies and/or waste, and take measures to remedy the deficiencies and/or reduce the waste. Further, because the tool is provided by way of a display board, rather than a computer system, those who may have an interest in the process may be able to view, access, and/or otherwise participate in the simulation. In addition, the results of the simulation and/or other information conveyed by the display board may be viewed by a variety of personnel simultaneously. Exemplary usage 50 of display board 22 will now be described.

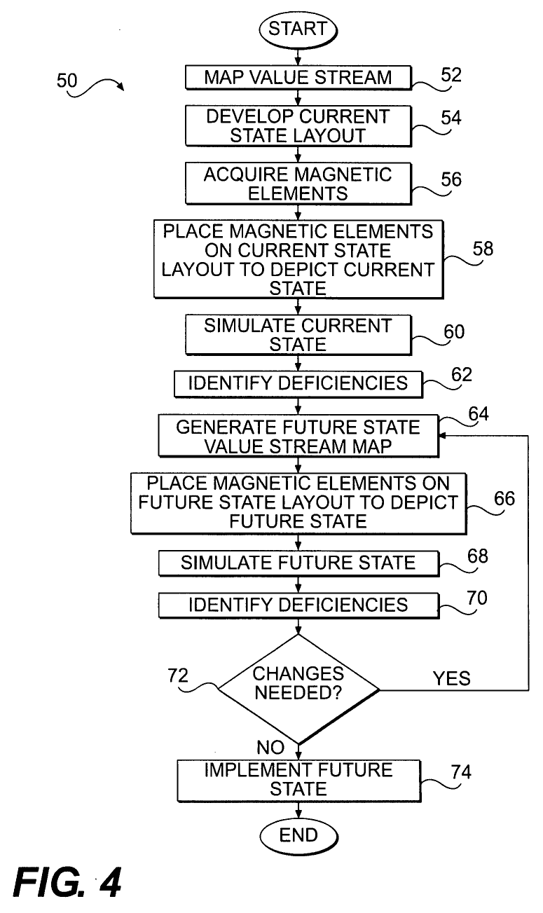

Referring to FIG. 4, business personnel may select and map a current state value stream of a particular business process (step 52). This may include identifying each step in the process, a cycle time for each step, a lead time for each step, an uptime for each step, a total processing time for each step, and/or other parameters of interest.

The business personnel may then develop a current state layout of the process based, at least in part, on the current state value stream map developed in step 52, and/or other knowledge about the process (step 54). This step may also include identifying the pertinent value stream entities to be tracked and/or monitored during simulation of the process. For example, the business personnel may determine that the products to be assembled (e.g., the vehicles); the subassemblies, components, and/or items to be installed; the inventory at each station of the production line; a working status of each station of the production line; the inventory on the production floor; and/or the time of day should be tracked during the simulation. The current state layout may then be created based on these determinations. That is, a hand- or computer-drafting a poster, a pictorial laminate, and/or other artwork to visually describe the layout of the process may be created and provided on display board 22.

Based on the pertinent value stream entities selected to be tracked during simulation, the business personnel may design and/or acquire appropriate magnetic elements 40 (step 56). That is, magnetic elements 40 including pictures, icons, images, shapes, and/or other features visually corresponding to and identifying a particular value stream entity, may be designed and/or acquired.

The business personnel may then place magnetic elements 40 on display board 22 and arrange magnetic elements 40 on current state layout 24 to describe a current state of process 26 (step 58). For instance, magnetic elements 40 may be placed in appropriate positions to reflect the beginning of a shift. A vehicle chassis magnetic element 42 may be placed at first step 26a of process 26 (FIG. 2). Additional magnetic elements 40 may be placed on markers 30a-e of first storage area 28. For example, engine magnetic elements 44a, transmission magnetic elements 44b, operator cabin magnetic elements 44c, hitch magnetic elements 44d, and wheel magnetic elements 44e may be placed on markers 30a-e in segments 30a-e, respectively. Further, additional vehicle engine 44a, transmission 44b, operator cabin 44c, and/or wheel magnetic elements 44e may be similarly arranged in second storage area 32 to reflect the current inventory on the production floor. A clock magnetic element 44h may be configured to indicate the shift starting time, and placed at a desired location on display board 22.

Next, the business personnel may simulate the current state of process 26 (step 60). That is, magnetic elements 40 may be selectively moved about layout 24 in accordance with the information gleaned from the current state value stream map created in step 52 (e.g., cycle times, lead times, uptimes, total processing times, and/or other parameters of interest). For instance, at first step 26a in process 26, an engine magnetic element 44a may be moved onto the vehicle chassis magnetic element 42 to simulate the work performed first step 26a. Further, the business personnel may place an “operational” status magnetic element 44f next to the first step of process 26 to indicate that work is being performed. Because the remaining downstream steps 26b-e are inactive (i.e., waiting for a vehicle to arrive at the respective station), “waiting” status magnetic elements 44g may be placed next to the downstream steps.

After first step 26a is complete (i.e., after the cycle time has elapsed), vehicle chassis magnetic element 42 and engine magnetic element 44a may be moved to second step 26b, where a transmission magnetic element 44b may be similarly placed on or near vehicle chassis magnetic element 42 and engine magnetic element 44a to simulate the work carried out at second step 26b. As such, the “waiting” status magnetic element 44g may be removed from second step 26b and replaced with an “operational” status magnetic element 44f to indicate that work is now being carried out at second step 26b. Likewise, the “operational” status magnetic element 44f at the first step may be removed and replaced with a “waiting” magnetic element 44g, until a new vehicle chassis is moved into first step 26a. Further, the clock magnetic element 44h may be updated to reflect the cycle time accrued by completion of the first step, in addition to any lead time accrued in progressing from first step 26a to second step 26b, initiating second step 26b, etc.

Those skilled in the art will appreciate that the simulation of process 26 may continue in this manner. For instance, magnetic elements 40 may be moved from second storage area 32 to first storage area 28 in accordance with known cycle times and/or lead times for restocking the various the line side storage areas (i.e., segments 28a-e). Likewise, second storage area 32 may be replenished in accordance with known delivery cycle times, lead times, shipment times, etc., associated with the various suppliers of the subassemblies, components, and/or items (e.g., the engine, transmission, operator cabin, wheels, etc.). Further, production errors may be simulated in accordance with known error rates and/or rework completion times of steps 26a-e.

During and/or after completion of the simulation, the business personnel may visually inspect display board 22 to identify waste and/or other deficiencies in process 26 (step 62). This step may include comparing aspects of the simulation shown on display board 22 to one or more value stream metrics or other benchmarks to which aspects of process 26 can be compared (e.g., efficiency, TAKT time, units completed, units in progress, capacity, downtime, etc.). In one example, the business personnel may notice that second step 26b is a bottleneck for the remaining downstream steps 26c-e, and that the vehicles are being completed at a rate below the TAKT time (i.e., the minimum rate of production required to meet customer demand). The business personnel may determine the root of the problem to be that the amount of transmission subassembly inventory maintained onsite is too low (i.e., the number of markers 34b in segment 32b), or that an additional worker is required at second step 26b to help install the transmissions and thereby reduce the cycle time for second step 26b.

In another example, the business personnel may evaluate the simulation of process 26 from a “lean” standpoint and/or other business efficiency principles. For example, it may be determined that the amount of engine subassembly inventory maintained onsite is too high (i.e., the number of markers 34a in segment 32a), and further, that a portion of the engine subassemblies cannot be used in process 26 because they are shipped from supplier 14 (FIG. 1) with manufacturing defects. As such, the business personnel may decide that the engine subassembly inventory maintained onsite in second storage area 32 should be reduced to save on costs associated with storing and maintaining extra engine inventory and handling the defective engine subassemblies.

Once all desired the deficiencies and/or wastes have been identified and solutions have been ascertained, the business personnel may generate a future state value stream map as discussed above in connection with step 52 (step 64). Likewise, a future state layout may be developed and provided on display board 22, and magnetic elements 40 may be placed on the future state layout to describe the future system (step 66). The business personnel may then simulate the future state layout, as discussed above, to see the results of the modification(s) to the initial state layout (step 68). It is to be appreciated that multiple layout scenarios may be implemented, if desired (i.e., “what-if” scenarios). The business personnel may then visually inspect display board 22 to identify waste and/or other deficiencies in process 26 (step 70), and determine if additional changes to the process are needed (step 72). If additional changes are needed, the business personnel may return to step 64, and continue with simulation of the new layout, as discussed above.

If, however, it is decided that changes to the future system are not needed, the business personnel may implement the future system (step 74). Implementing the future system may include, for example, redefining the roles and responsibilities within the business (e.g., assign a new task to a worker); training those who may be affected by the changes (e.g., train a worker to work at a new station); place new orders and/or cancel or modify pending orders with suppliers; add or remove manufacturing equipment; etc.

By employing the disclosed display board and magnetic elements to describe, model, and/or simulate a value stream process those, who may have an interest in the process may be able to view, access, and/or otherwise participate in the simulation. Specifically, because the simulation may be displayed by way of a board, rather than a computer system, the information contained on and/or conveyed by the simulation may be viewed by a variety of personnel simultaneously. In this manner, the communication and implementation of business process changes may be more effective.

It will be apparent to those skilled in the art that various modifications and variations can be made to the disclosed systems and methods. Other embodiments will be apparent to those skilled in the art from consideration of the specification and practice of the disclosure. For example, although the systems and methods are disclosed above with respect to a manufacturing process, it is contemplated that the disclosure may equally apply to other types of process associated with other value streams (e.g., a concept-to-launch value stream, a raw material-to-finished-good value stream, an information technology value stream, etc.). It is intended that the specification and examples be considered as exemplary only, with a true scope being indicated by the following claims and their equivalents.

What is claimed is:

1. A method, comprising:
developing an initial value stream map for a process;
identifying a plurality of entities to be monitored during completion of the process based on the initial value stream map;
determining an initial layout of the process based on the plurality of entities to be monitored;
providing the initial layout of the process on a metallic display board; and
placing magnetic elements corresponding to the plurality of entities on the initial layout to describe the process.

2. The method of claim 1, wherein the magnetic elements each include a visual distinction corresponding to a respective one of the plurality of value stream entities.

3. The method of claim 2, wherein the visual distinction includes at least one of a color, an icon, an image, and a picture.

4. The method of claim 1, further including simulating the process by moving the magnetic elements about the initial layout in accordance with the completion of the process.

5. The method of claim 4, further including:
visually inspecting the initial layout and the magnetic elements thereon during and/or after the simulation; and
identifying a deficiency in the process based on the visual inspection.

6. The method of claim 5, further including:
determining a process modification to remedy the deficiency;
creating a future value stream map based on the modification; and
determining a future layout of the process based on the future value stream map.

7. The method of claim 6, further including updating the metallic display board to reflect the future layout and the process modification.

8. The method of claim 6, further including simulating the modified process by moving the magnetic elements about the future layout accordance with the completion of the modified process.

9. The method of claim 5, wherein identifying a deficiency includes comparing an aspect of the simulation to a value stream metric.

10. The method of claim 9, wherein the value stream metric includes one of a cycle time and a TAKT time.

11. The method of claim 1, wherein the initial layout includes steps in the process.

12. A method of improving a process, comprising:
developing a value stream map for the process;
identifying a plurality of entities to be monitored during completion of the process based on the value stream map;
determining a layout of the process based on the plurality of entities to be monitored;
providing the layout of the process on a metallic display board; and
placing magnetic elements corresponding to the plurality of entities on the layout to describe the process.

13. The method of claim 12, wherein the magnetic elements each include a visual distinction corresponding to a respective one of the plurality of value stream entities.

14. The method of claim 13, wherein the visual distinction includes at least one of a color, an icon, an image, and a picture.

15. The method of claim 12, further including simulating the process by moving the magnetic elements about the layout in accordance with the completion of the process.

16. The method of claim 15, further including:
visually inspecting the layout and the magnetic elements thereon during and/or after the simulation; and
identifying a deficiency in the process based on the visual inspection.

17. The method of claim 16, further including:
determining a process modification to remedy the deficiency; and
implementing the process modification.

18. The method of claim 16, wherein identifying a deficiency includes comparing an aspect of the simulation to a value stream metric.

19. The method of claim 18, wherein the value stream metric includes one of a cycle time and a TAKT time.

20. The method of claim 11, wherein the layout includes steps in the process.
